(19) United States
(12) Patent Application Publication
(10) Pub. No.: US 2015/0112572 A1
(43) Pub. Date: Apr. 23, 2015

(54) CENTRALIZED ACTUATOR CONTROL MODULE

(71) Applicants: Oswald Baasch, Bowling Green, KY (US); Paul Gottemoller, Palos Park, IL (US); Luis Carlos Cattani, Aurora, IL (US); Jon A. Bigley, Bowling Green, KY (US)

(72) Inventors: Oswald Baasch, Bowling Green, KY (US); Paul Gottemoller, Palos Park, IL (US); Luis Carlos Cattani, Aurora, IL (US); Jon A. Bigley, Bowling Green, KY (US)

(73) Assignee: International Engine Intellectual Property Company LLC, Lisle, IL (US)

(21) Appl. No.: 14/407,370

(22) PCT Filed: Jun. 11, 2012
(86) PCT No.: PCT/US12/41827

§ 371 Date: Dec. 11, 2014

(51) Int. Cl. F02D 29/02

(52) U.S. Cl. CPC F02D 29/02; F02D 2700/07
USPC 701/101

(57) ABSTRACT

An apparatus for controlling a plurality of actuators that assists in controlling the operation of a motorized vehicle. The apparatus includes a centralized actuator control module that is positioned remotely from an engine control unit. The centralized actuator control module includes a processor that is configured to control the operation of the actuators. The apparatus may include a first communication cable that is configured to deliver information between the centralized actuator control module and the engine control unit. An actuator communication cable may be configured to deliver power from the centralized actuator control module to one or more of the plurality of actuators. The apparatus may include a second communication cable configured to deliver sensed data to the centralized actuator control module that the centralized actuator control module uses to determine whether to operate one or more of the actuators.

### BACKGROUND

An engine control unit (ECU) is often used to control various operations of a motorized vehicle. For example, an ECU may control the operation of a vehicle's internal combustion engine, such, as, for example, by controlling the rate or amount of fuel that is supplied through a fuel injector to a combustion chamber, the air-to-fuel ratio, ignition timing, and idle speed, among other controls.

The ECU typically receives data or signals from a number of different components, such as, for example, sensors. For example, the ECU may receive data indicating the sensed temperature of engine coolant at a particular location along the engine coolant system, or the distance that a driver has depressed or displaced the accelerator. The ECU also transmits data or instructions to various engine and/or vehicle components. Such transmissions are often used to control the operation of actuators and other control devices, such as, for example, relays, solenoids, or motors, including stepper motors, BLDC motors, and PMDC motors. Further, the actuators may be electro-pneumatic, electro-hydraulic, or electronic. For example, instructions from the ECU to the actuator may be used to have the actuator change the position of a valve that is operably connected to the actuator, including, for example, valves that control the amount or rate of fuel passing through a fuel injector or the air-to-fuel ratio of the fuel mixture being combusted. Yet, typically, the ECU processors or microcontrollers are set for specific functions with minimal input/output (I/O) being available to run additional valves and/or actuators.

ECUs typically have a relatively large number of I/O ports. Such I/O ports are connected to a number of wires or other electrical connections that allow for the transmission and/or receipt of data between the ECU and the connected engine and vehicle components. However, the number of I/O ports on the ECU is typically limited to the physical size of the ECU's housing. Therefore, increasing the number of I/O ports to accommodate new or additional components or sensors typically requires enlarging the size of the ECU housing. However, an increase in the number of components connected to the ECU through the I/O ports often also requires increasing the number of microprocessors or other associated electronics in the ECU that are needed to drive the actuators being controlled by the ECU, which may also further increase the size and complexity of the ECU.

Further, having a relatively large number of I/O ports on the ECU and the associated electrical components in the ECU may adversely impact the overall performance of the ECU. For example, as the number of components connected to the ECU, and the associated processing requirements within the ECU increases, so does the potential for electromagnetic (EMC) and/or radio frequency (RF) interference in the ECU, as well as the complexity of the ECU being able to deal with such interference. Moreover, driving actuators may require relatively high driving currents that can cause RF/EMC interference if not managed accordingly. Such RF/EMC management at high driving currents typically requires large components that might drive the real estate requirement on the ECU to sizes not easily packagable. Additionally, the complexity of the ECU's ability to deal with load dumps associated with changes in voltage across the ECU may also increase. Such challenges may only be further exacerbate when the number of I/O ports on the ECU are increase to accommodate new or additional engine control or operation features.

Additionally, the ECU is typically positioned at a location that prevents or minimizes the ECU's exposure to temperatures or other engine operating conditions that may adversely impact the performance of the ECU, or may accelerate any deterioration in the physical condition of the ECU. However, as the ECU may be connected to various engine components located at different positions in the engine compartment or vehicle, long, and in some instances, multiple, communication wires, harnesses, or other complex connectors many be required for the ECU to communicate with the various components. At least a portion of these cables, harness, or connectors may therefore be located at, or pass, portions of the engine compartment or vehicle that are subjected to harsh operational or environmental conditions, which may accelerate the deterioration in their physical condition.

### BRIEF SUMMARY

Embodiments depicted herein provide an apparatus for controlling at least one actuator. The apparatus includes a centralized actuator control module that is positioned remotely from an engine control unit. The centralized actuator control module includes a processor that is configured to control the operation of the at least one actuator. The apparatus also includes an actuator cable that is configured to deliver power from the centralized actuator control module to the at least one actuator to drive the operation of the at least one actuator.

Another embodiment provides an apparatus for controlling a plurality of actuators that assist in controlling the operation of a motorized vehicle. The apparatus includes a centralized actuator control module that is positioned remotely from an engine control unit. The centralized actuator control module includes a processor to control the operation of the plurality of actuators. The apparatus also includes a first communication cable that is configured to deliver information between the centralized actuator control module and the engine control unit. Additionally, the apparatus may further include a power cable that is configured to deliver power to the centralized actuator control module. Further, the apparatus may include an actuator communication cable that is configured to deliver power from the centralized actuator control module to one or more of the plurality of actuators to drive the operation of at least one of the plurality of actuators.

Another embodiment provides an apparatus for controlling a plurality of actuators that assist in controlling the operation of a motorized vehicle. The apparatus includes an engine control unit and a centralized actuator control module. The centralized actuator control module is positioned remotely from the engine control unit. Further, the centralized actuator control module has a processor that is configured to control the operation of the plurality of actuators. The apparatus also includes a first communication cable that is configured to deliver information between the centralized actuator control module and the engine control unit. Additionally, the apparatus includes an actuator communication cable that is configured to deliver power from the centralized actuator control module to one or more of the plurality of actuators. The apparatus further includes a second communication cable that is configured to deliver sensed data to the centralized actuator control module. The sensed data may be used by the centralized actuator control module to determine whether to operate at least one of the plurality of actuators.

### BRIEF DESCRIPTION OF THE DRAWINGS

FIG. 1 illustrates an exemplary schematic of a communication system having a centralized actuator control module for controlling fluid and gas modulation in internal combustion engines.

### DETAILED DESCRIPTION

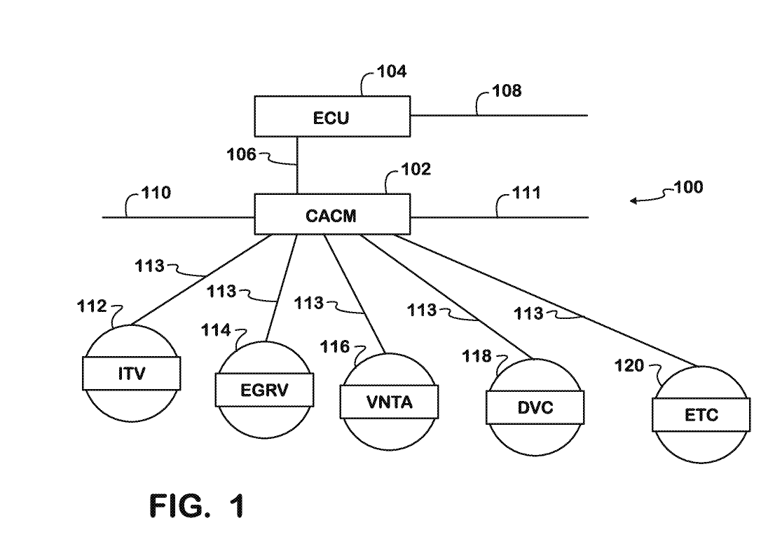

FIG. 1 illustrates an exemplary schematic of a communication system 100 having a centralized actuator control module (CACM) 102 for controlling fluid and gas modulation in internal combustion engines. As shown, the CACM 102 is positioned remotely from the ECU 104. Thus, the CACM 102 and ECU 104 may communicate through a first communication cable 106, which may include one or more controller area network (CAN), pulse width-modulation, FlexRay™, LIN, or RS-232 cables, or involve communication via Bluetooth or any other electronics communication bus. The ECU may also be connected to an ECU communication cable 108, which may transmit data to or from the ECU 104 and other components within the engine or vehicle.

According to certain embodiments, the CACM 102 includes a processor that is configured to interpret data or instructions received by the CACM 102 from the ECU 104. Additionally, the main processor of the CACM 102 is also configured to interpret data or instructions received via a second communication cable 111. The second communication cable 111 may be operably connected to sensors positioned in various locations of the engine, vehicle, and/or other control modules. For example, the second communication cable 111 may be operably connected to a sensor that provides data indicating the displacement or position of an accelerator pedal that has been depressed by a user. According to certain embodiments, the second communication cable 111 may be the same type of cable used by the first communication cable 106.

By removing the circuitry associated with controlling the particular actuators from the ECU 102 to the CACM 102, the design of the ECU 104 may be simplified. Additionally, such a modification may also reduce the physical size of the ECU 104. Further, the configuration of the CACM 102 may be simplified, as the CACM 102 may have only the circuitry, software, and firmware necessary to support the particular type(s) of actuator(s) that the CACM 102 is actually controlling. More specifically, only the circuits required for the applications being controlled by the CACM 102 need to be populated, which may thereby allow for the PCB layout to be optimized for the particular applications being controlled by the CACM 102. Moreover, such a design may allow for a single processor to control the various actuators 112, 114, 116, 118, 120, as opposed to having an ECU with multiple processors for different actuators. Thus, the design may provide for the use of a processor that is configured for a larger variety of functions, such as driving a variety of different actuators, than the processors often used in current ECU devices.

Such a configuration also allows the CACM 102 to use uniform controls or protocols to address potential electromagnet (EMC) and radio frequency (RF) interference or load dump requirements for the CACM 102 and associated actuators. Moreover, actuators or other motor drivers generally require relatively high driving current, and thus the PCB of the CACM 102 may be specifically designed to accommodate such a function.

The CACM 102 is also configured to receive power through a power cable 110. The power may be delivered from the vehicle's or engine's battery or electrical system. This power may be used at least in part for the operation of the microprocessor in the CACM 102, as well as to drive the actuators 112, 114, 116, 118, 120 that are controlled by the CACM 102.

As shown in FIG. 1, the CACM 102 is operably connected to one or more actuators 112, 114, 116, 118, 120 by an actuator communication cable 113. The actuators 112, 114, 116, 118, 120 may be air, exhaust, and turbo actuators, among others, or any combination thereof. According to certain embodiments, the actuator communication cable 113 may include a power cable that is used by the CACM 102 to drive an actuator 112, 114, 116, 118, 120. The actuator communication cable 113 may also include a feedback cable that may provide sensed information back to the CACM 102 relating to the operation of the actuator 112, 114, 116, 118, 120 or the operation of the engine component associated with the actuator 112, 114, 116, 118, 120, such as the position of the associated valve. Such feedback may not only allow the CACM 102 to be apprised of the current condition or position of the actuator 112, 114, 116, 118, 120 and/or the operation of its related engine component, but may also allow be used by the CACM 102 and/or ECU 104 when performing diagnostic checks.

For example, in the illustrated embodiment, the CACM 102 communicates through an actuator communication cable 113 with the actuator 112 that changes the position, such as opening (fully or to a degree) and closing, an intake throttle valve (ITV). Operation of the actuator 112 may cause a change in position in the ITV, such as changing the ITV from being open to closed, or vice versa, or the degree to which the ITV is open. Such changes in the position of the ITV may alter and/or control the amount of oxygen mixed with the fuel, and thereby increase or decrease the engine's power. When the CACM 102 determines the position of the ITV is to be changed, the CACM 102 may deliver electrical power to the actuator 112 that drives the actuator 112. The amount of power delivered and/or the duration that power is delivered may depend on the type of actuator being employed and/or the desired change in position or operation of the ITV. For example, certain actuators, such as stepper motors, may be designed to operate for only the period of time in which electrical power is being supplied to the actuator through the actuator communication cable 113, while other types of actuators, such as solenoids, may operate for a predetermined period of time after receiving electrical power through the actuator communication cable 113. Further, feedback information or data, such as, for example, the status of the actuator, the position of the ITV, or the sensed air-to-fuel mixture, may be transmitted to the CACM 112 via one or more feedback wires in the actuator communication cable 113.

As previously discussed, the CACM 102 may control one or more actuators used to operate a variety of engine components and operations. For example, as shown in FIG. 1, besides controlling the actuator 112 associated with the ITV, the CACM may also drive actuators 114, 116, 118, 120 associated with an exhaust gas recirculation valve (EGRV), a variable vane turbo actuator (VNTA), digital valve controller (DVC), and an electronic throttle control (ETC), respectively.

By being positioned remotely from the ECU 104, the CACM 102 may be located in relatively close proximity to the actuators 112, 114, 116, 118, 120 that the CACM 102 controls. For example, according to certain embodiments, the remotely positioned CACM 102 may be positioned at a relatively cool location in the engine compartment that may allow the actuator communication cables 113 to be shorter, or require fewer extension cables, than when the actuator communication cables 113 are connected to I/O ports of the ECU 104. Further, the remote CACM 102 may be positioned such that the actuator communication cables 113 do not need to pass through areas of the engine compartment that are exposed to relatively harsh operation or environmental conditions that could cause premature deterioration or corrosion of the cables 113.

According to certain embodiments, the CACM 102 may be positioned in or on one of actuators 112, 114, 116, 118, 120 that is controlled by the CACM 102. For example, according to certain embodiments, the CACM 102 may be positioned in a portion of a housing of the most centrally positioned actuator 116. According to another embodiment, the CACM 102 may be positioned on or in the actuator 112, 114, 116, 118, 120 having the lowest operating temperature, such as for example, the temperature the actuator is subjected to during vehicle or engine operation and/or the operational temperature that the actuator is subjected to from the environment of the valve being driven by the actuator. According to another embodiment, the CACM 102 may be operably secured or attached to the actuator, such as for example, being bolted or otherwise mechanically fastened to a housing of an actuator 112, 114, 116, 118, 120. Alternatively, the actuator 112, 114, 116, 118, 120 may be formed or manufactured to include a housing for the CACM 102. Additionally, the CACM 102 allows the processors or microcontrollers used to operate the actuators to be separated from higher end electronics that are typically also located in the ECU. Thus, by moving such processors to the CACM 102, and away from the high end electronics that remain in the ECU, the CACM 102 may be more compatible than the ECU to being located at a position that exposes the CACM 102 to higher engine or vehicle operating temperatures.

1. An apparatus for controlling at least one actuator, the apparatus comprising:
a centralized actuator control module positioned remotely from an engine control unit, the centralized actuator control module having a processor that is configured to control the operation of the at least one actuator; and
an actuator communication cable configured to deliver power from the centralized actuator control module to the at least one actuator to drive the operation of the at least one actuator.

2. The apparatus of claim 1, wherein the centralized actuator control module is located within or on one of the at least one actuator.

3. The apparatus of claim 1, wherein the at least one actuator is a plurality of actuators that includes a centrally located actuator, the centrally located actuator being positioned at a centralized location among the plurality of actuators, and wherein the centralized actuator control module is located within or on the centrally located actuator.

4. The apparatus of claim 1, wherein the at least one actuator is a plurality of actuators, and wherein the centralized actuator control module is located within or an actuator of the plurality of actuators that is subjected to the lowest operational temperature.

5. The apparatus of claim 1, further including a communication cable configured to deliver sensed data to the centralized actuator control module, the sensed data being used by the centralized actuator control module to determine whether to operate the at least one actuator.

6. An apparatus for controlling a plurality of actuators that assist in controlling the operation of a motorized vehicle, the apparatus comprising:
a centralized actuator control module positioned remotely from an engine control unit, the centralized actuator control module having a processor that is configured to control the operation of the plurality of actuators;
a first communication cable configured to deliver information between the centralized actuator control module and the engine control unit;
a power cable configured to deliver power to the centralized actuator control module; and
an actuator communication cable configured to deliver power from the centralized actuator control module to one or more of the plurality of actuators to drive the operation of at least one of the plurality of actuators.

7. The apparatus of claim 6, wherein the centralized actuator control module is located within or on one of the plurality of actuators.

8. The apparatus of claim 6, further including a second communication cable configured to deliver sensed data to the centralized actuator control module, the sensed data being used by the centralized actuator control module to determine whether to operate at least one of the plurality of actuators.

9. The apparatus of claim 8, wherein the sensed data indicates a degree of depression of an accelerator pedal in the motorized vehicle.

10. The apparatus of claim 9, wherein the plurality of actuators include an actuator that moves an intake throttle valve between a closed position and an open position, the actuator being driven by the centralized actuator control module after the centralized actuator control module receives sensed data that indicates the degree of depression of the accelerator pedal.

11. An apparatus for controlling a plurality of actuators that assist in controlling the operation of a motorized vehicle, the apparatus comprising:
an engine control unit;
a centralized actuator control module positioned remotely from the engine control unit, the centralized actuator control module having a processor that is configured to control the operation of the plurality of actuators;
a first communication cable configured to deliver information between the centralized actuator control module and the engine control unit;
an actuator communication cable configured to deliver power from the centralized actuator control module to one or more of the plurality of actuators; and
a second communication cable configured to deliver sensed data to the centralized actuator control module, the sensed data being used by the centralized actuator control module to determine whether to operate at least one of the plurality of actuators.

12. The apparatus of claim 11, further including a power cable operably connected to the centralized actuator control module, and wherein the actuator communication cable is configured to deliver power from the centralized actuator control module to at least one of the plurality of actuators.

13. The apparatus of claim 12, wherein the actuator communication cable includes a feedback cable that delivers information or data to the centralized actuator control module.

14. The apparatus of claim 13, wherein the sensed data delivered by the second communication cable indicates a degree of depression of an accelerator pedal in the motorized vehicle.

15. The apparatus of claim 11, wherein the centralized actuator control module is located within or on one of the plurality of actuators.
